(19) United States
(12) Patent Application Publication
(10) Pub. No.: US 2002/0119324 A1
(43) Pub. Date: Aug. 29, 2002

(54) Charging member, charging device and manufacture of charging roller

(75) Inventors: Hiroshi Harashima, Yokohama-shi (JP); Shohei Morikawa, Yokohama-shi (JP); Tomoyuki Yusa, Yokohama-shi (JP); Yasushi Inoue, Fujisawa-shi (JP); Takeshi Murayama, Yokohama-shi (JP)

Correspondence Address: SUGHRUE MION, PLLC, 2100 Pennsylvania Avenue, NW, Washington, DC, 20037-3213, US

(73) Assignee: BRIDGESTONE CORPORATION

(21) Appl. No.: 09/984,709

(22) Filed: Oct. 31, 2001

(30) Foreign Application Priority Data
Nov. 2, 2000 (JP) 2000-336561
Nov. 2, 2000 (JP) 2000-336563
Nov. 20, 2000 (JP) 2000-353547
Oct. 24, 2001 (JP) 2001-325833

(51) Int. Cl. B32B 27/40; G03G 15/02

(52) U.S. Cl. 428/423.3; 399/176; 428/424.8; 428/425.5; 492/56; 492/59

(57) ABSTRACT

In order to obtain a charging member which is free of problems such as bleeding of a conductive agent and environment dependency, has little voltage dependency, and can be preferably used in a charging system of impressing only a DC voltage, there is provided a charging member comprising an elastic layer, a resistance regulation layer provided on the elastic layer, and a skin layer provided on the resistance regulation layer, wherein the resistance regulation layer is formed by use of a resin composition prepared by blending an ion conductive substance having a molecular weight of 30 to 800 as a conductive agent into a low-resistance resin matrix having a resistance of 1×10⁴ to 1×10¹⁰ Ω·cm.

In the case of obtaining a charging roller by dipping rollers in a coating material to form coating films on the surfaces of the rollers, \mathring{1} the temperature of the coating material at the time of a dipping treatment is appropriately controlled, \mathring{2} the temperatures of the rollers at the time of the dipping treatment are appropriately controlled, or \mathring{3} air-blowing conditions in blowing air to the rollers to dry the coating films are appropriately controlled, whereby a charging roller with high quality can be obtained securely and stably without generating problems on a production basis such as liquid sag of the coating material and unevenness of coating film thickness.

### BACKGROUND OF THE INVENTION

The present invention relates to a charging member such as a charging roller used preferably in the case of charging a body to be charged, such as a photosensitive body, by an electrostatic latent image process in copying machines, printers and the like, a charging device using the charging member, and a method of manufacturing a charging roller.

Hitherto, in an electrophotographic device such as copying machines, printers and the like, a method has been adopted in which the surface of a photosensitive body is first charged uniformly, an electrostatic latent image is obtained by an electrostatic latent image process of forming a latent image by projecting an image from an optical system onto the photosensitive body to eliminate the charge at the portions irradiated with light, then a toner image is formed by adhesion of a toner, and printing is conducted by transferring the toner image onto a recording medium such as paper.

In this case, the first operation of charging the photosensitive body has generally been achieved by adopting a corona discharge system. However, the corona discharge system requires impression of a high voltage as high as 6 to 10 kV, and this is undesirable from the viewpoints of safety and maintenance of the machine. In addition, since harmful substances such as ozone and NOx are generated during the corona discharge, there is an environmental problem.

Therefore, development of a charging system by which charging can be achieved by impression of a lower voltage than that in the corona discharge and generation of the harmful substances such as ozone can be restrained has been conducted. As a new charging system, a method has been proposed in which the body to be charged is charged by a contact system of bringing the charging member with a voltage impressed thereon into contact with the body to be charged such as a photosensitive body at a predetermined pressure.

In this case, as the charging member used in the contact charging system, there has been known, for example, one in which a resistance regulation layer regulated in resistance by adding a conductive agent to a resin such as urethane, acrylurethane, acrylic ester and nylon or a synthetic rubber such as NBR is provided on the surface of an elastic layer composed of a rubber, urethane foam or the like, and a resin solution prepared by dissolving a resin such as acrylic resin, urethane resin and nylon in an organic solvent is applied to the resistance regulation layer by a dipping method to form a skin layer.

However, these conventional charging members are ordinarily used in the case of charging the photosensitive body or the like by impressing a superimposed voltage of a DC voltage and an AC voltage, and cannot be used in the case of charging the photosensitive body or the like by impressing only a DC voltage without superimposing an AC voltage.

Namely, in the system of charging the photosensitive body by impressing a superimposed voltage of a DC voltage and an AC voltage, a charging member having voltage dependency is required, but, when the charging member having voltage dependency is used in the charging system of impressing only a DC voltage, image defects such as ghost, unevenness of image due to nonuniform charging, lateral streaks and leak would be generated. Thus, the charging member having voltage dependency cannot be applied to the charging system of impressing only a DC voltage.

In this case, in order to eliminate the voltage dependency of the charging member, use of an ion conductive agent instead of an electron conductive filler as a conductive agent blended in the above-mentioned resistance regulation layer is generally adopted.

However, since the resin material used for forming the resistance regulation layer generally has a high electrical resistance of 1×10¹³ to 1×10¹⁵ Ω·cm, a large amount of the ion conductive substance must be added in order to achieve a predetermined conduction property. In this case, the large amount of the ion blended in the resin generates bleeding to the surface of the member and the inconvenience of a lower resistance under high-temperature high-humidity conditions and a higher resistance under low-temperature low-humidity conditions, and, therefore, such a charging member cannot be used because of the conspicuous environment dependency of the performance. In addition, according to the kind of the ion used, it may be difficult to even display the required conduction property.

Accordingly, there is a request for development of a charging member which does not generate the problems of the bleeding of the conductive agent, environment dependency and the like, has a little voltage dependency, and can be preferably used for the charging system of impressing only a DC voltage.

On the other hand, the above-mentioned resistance regulation layer and the skin layer are generally formed by a dipping method in which the roller is immersed in a coating material prepared by dissolving the resin for forming these layers, followed by drying. In order to obtain a uniform and high image quality, it is important that the application of the coating material by dipping is uniform, and, for this purpose, it is important that the treatment conditions such as temperature control in the dipping treatment are appropriate.

Conventionally, however, although the temperature control of the coating material under storage has been sufficiently performed, temperature control of the coating material at the time of coating and temperature control on the roller side have not necessarily been conducted rigorously.

Although the method of dipping the roller in the coating material to form the coating film is a very excellent method as a method of manufacturing a charging roller, uneven application of the coating material leads to problems as to image quality. For example, when the temperature of the base member is too high relative to the temperature of the coating material, bubbles or films are liable to be formed at the surface of the coating material, and when the temperature of the base member is too low relative to the temperature of the coating material, liquid sag or liquid pool of the coating material is liable to be generated; in both cases, uniform coating cannot be achieved. These problems are conspicuous particularly in the case of using a water-based coating material.

Besides, in the actual site of manufacture, it is a general practice that 30 or more rollers are hung from a single hanger, and are simultaneously subjected to the dipping treatment, where it is important to make constant the temperature of all the rollers.

Further, generally, the rollers enter the coating step after passing through a drying step, and the rollers are always preheated to a certain temperature in the drying step. However, if the production line is stopped for some reason, the roller stopped in the vicinity of an outlet of the drying furnace has a lowered temperature. In addition, a temperature difference is generated between the roller stopped at a position near the drying furnace and the roller stopped at a position away from the drying furnace, so that there is a dispersion of temperature of the rollers at the time of dipping.

Therefore, there is a request for a measure for securely preventing the lowering in performance of the charging rollers arising from the control of conditions at the time of the dipping treatment.

Meanwhile, in the dipping step for applying the coating material to the surfaces of the charging rollers, the coating material applied must be dried. Conventionally, however, it has been a general practice to achieve drying by natural drying or by laterally blowing air to the coating material applied rollers hung from a hanger or hangers. However, the manner of collision of the airflows is not uniform for all hangers or all rollers, and there is a difference in drying time of the rollers between the windward side and the leeward side. Besides, in the case of laterally blowing air to the rollers, there is a difference in drying time on the windward side and the leeward side even for one roller, which causes unevenness of the coating film.

In this case, when the thickness of the coating film is not uniform on the entire surface of the roller and the coating material is not uniformly dried, problems as to image are generated. When the drying of the coating material is slow, sag of the coating material is generated, and a liquid pool with a large material thickness is formed at the lower end on the leeward side of the roller disposed vertically, so that the roller obtained cannot be used as a product.

Thus, in the case of hanging a multiplicity of rollers from a single hanger, simultaneously subjecting the multiplicity of rollers to the dipping treatment and drying the coating material on the rollers by blowing air to the rollers, blowing air to all the rollers at a fixed air velocity is extremely important from the viewpoint of product quality and productivity.

Therefore, there is a request for a measure for uniformly supplying airflow to all rollers and thereby securely preventing the lowering of performance or lowering of productivity due to unevenness of drying conditions, in the case of simultaneously dipping a plurality of rollers in a coating material and drying the coating material on the rollers by blowing air to the rollers.

### SUMMARY OF THE INVENTION

The present invention has been made in consideration of the above situations. Accordingly, it is a first object of the present invention to provide a charging member by which such problems as bleeding of a conductive agent and environment dependency are obviated, a charging member having little voltage dependency can be obtained, and which can be preferably used in a charging system of impressing only a DC voltage, and a charging device using the charging member.

In view of the above situations, it is a second object of the present invention to provide a method of manufacturing a charging roller by which it is possible to restrain the lowering of performance and productivity of a charging roller due to the problems as to control of temperatures of a coating material solution and rollers in the case of forming a coating film by a dipping method and the problems as to drying conditions, and to obtain a charging roller having good performance at good productivity.

The present inventors have made intensive and extensive studies for attaining the above first object. As a result of the studies, it has been found that, in the case of obtaining a charging member by forming a resistance regulation layer on an elastic layer serving as a base layer of the member and forming a skin layer on the resistance regulation layer, when a low resistance resin having an electrical resistance of 1×10⁴ to 1×10¹⁰ Ω·cm is used as a matrix resin for forming the resistance regulation layer and an ion conductive substance having a molecular weight of 30 to 800 is used as a conductive agent added to the low resistance resin, a predetermined resistance value can be attained while reducing the amount of the ion conductive substance added, generation of bleed-out of the ion conductive substance can be restrained as much as possible, a charging member having very little voltage dependency can be obtained, the charging member can attain good performance as to environment dependency and current passing durability, and a charging member preferably used in the charging system of impressing only a DC voltage can be obtained. Based on the findings, a first-named invention as below has been completed.

Namely, as the first-named invention for attaining the above first object, there are provided a charging member for charging a body to be charged by bringing the charging member into contact with the body to be charged and impressing a voltage between the charging member and the body to be charged, wherein the charging member comprises an elastic layer, a resistance regulation layer formed on the elastic layer, and a skin layer formed on the resistance regulation layer, and the resistance regulation layer is formed from a resin composition prepared by blending an ion conductive substance having a molecular weight of 30 to 800 with a low resistance resin matrix having a resistance of 1×10⁴ to 1×10¹⁰ Ω·cm, and

a charging device comprising a charging member for charging a body to be charged by making contact with the body to be charged, and a voltage impressing means for impressing a DC voltage between the body to be charged and the charging member, wherein the above-mentioned charging member is used.

On the other hand, the present inventors have made intensive and extensive studies for attaining the above second object. As a result of the studies, it has been found that, as to temperature control of a coating material solution, in the case of dipping rollers in a coating material to form a coating film on the surface of each roller, when the coating operation by dipping is conducted while keeping the coating material at a substantially fixed temperature at a predetermined temperature in the range of 25 to 35° C., a uniform dipping treatment can be performed, and a charging roller with high quality can be obtained. Based on the findings, a method of manufacturing a charging roller as below according to a second-named invention has been completed.

In addition, it has been found that, as to temperature control on the side of the rollers subjected to the dipping treatment, in the case of simultaneously dipping a plurality of rollers in a coating material to form a coating film on the surface of each roller, when the coating operation by dipping is conducted while keeping the temperature of the plurality of rollers immediately before the dipping at a substantially uniform temperature over all the rollers, uniform coating with the coating material can be securely performed, and a charging roller with high quality can be securely obtained. Based on the findings, a third-named invention has been completed.

Furthermore, it has been found that, as to drying conditions after coating with a coating material, in the case of substantially vertically hanging a plurality of rollers provided on their surfaces with coating films by a dipping treatment and blowing air to the hung rollers to dry the coating films, when air is blown from the lower side toward the upper side of the rollers to dry the coating films, uniform coating films can be securely obtained, and a charging roller with high quality can be obtained. Based on the findings, a fourth-named invention has been completed.

Namely, in order to attain the above-mentioned second object, the present invention provides:

a method of manufacturing a charging roller comprising a step of dipping a roller in a coating material to form a coating film on the surface of the roller, wherein the dipping treatment is conducted while keeping the coating material at a substantially fixed temperature at a predetermined temperature in the range of 25 to 35° C., as the second-named invention;

a method of manufacturing a charging roller comprising a step of simultaneously dipping a plurality of rollers in a coating material to form coating films on the surfaces of the rollers, wherein the temperatures of the plurality of rollers immediately before dipping are kept at a substantially uniform temperature over all the rollers, as the third-named invention; and

a method of manufacturing a charging roller comprising a step of dipping a roller in a coating material to form a coating film on the surface of the roller, wherein a plurality of rollers provided on their surfaces with coating films by the dipping are hung substantially vertically, and air is blown from the lower side toward the upper side of the rollers to dry the coating films, as the fourth-named invention.

### BRIEF DESCRIPTION OF THE DRAWINGS

FIG. 1 is a general sectional view showing as an example a charging member according to the first-named invention;

FIG. 2 is a general view showing an example of a charging device according to the first-named invention;

FIG. 3 is a general side view showing the situations of carrying out a manufacturing method according to the third-named invention;

FIG. 4 is a plan view schematically showing the situations of carrying out the manufacturing method according to the third-named invention;

FIG. 5 is a front view of a drying device schematically showing the situations of carrying out a manufacturing method according to the fourth-named invention; and

FIG. 6 is a plan view schematically showing a section along line II-II of FIG. 5.

### DETAILED DESCRIPTION OF THE INVENTION

Now, the present invention will be described in detail below on the basis of each named invention.

### First-named Invention

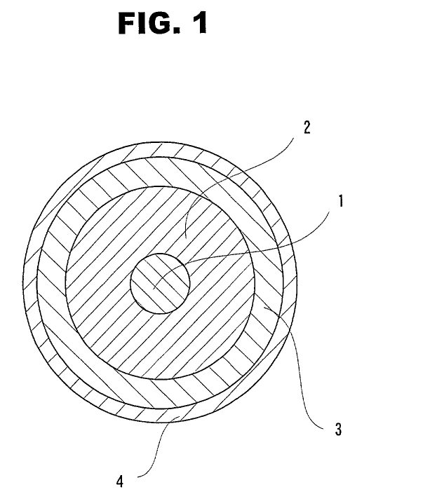

The charging member according to the first-named invention, as above-mentioned, is one in which a resistance regulation layer is formed by use of a resin composition prepared by blending an ion conductive substance having a molecular weight of 30 to 800 with a low-resistance resin matrix having a resistance of 1×10⁴ to 1×10¹⁰ Ω·cm. For example, as shown in FIG. 1, a roller form charging member may be set forth as an example in which an elastic layer 2 is formed on the outer periphery of a core 1, a resistance regulation layer 3 composed of the above-mentioned specific resin composition is provided on the elastic layer 2, and a skin layer 4 is provided on the resistance regulation layer 3.

As the above-mentioned core 1, a metal-made or plastic-made shaft may be used. While the roller form member is shown in FIG. 1, the form of the charging member according to the first-named invention is not limited to the roller form, and may be any appropriate form such as plate form, sphere form, brush form, block form and the like. The shape of the core 1 may be appropriately modified according to the form of the charging member, and the core 1 may even be omitted according to the form of the charging member or the mechanism of the charging device in which the charging member is used.

Next, the above-mentioned elastic layer 2 is not specifically limited, and may be any elastic body that can obtain a good contact condition with the body to be charged such as a photosensitive body. The elastic layer 2 may be formed of a known rubber or resin or a foamed body (hereinafter referred to as “foam”) of the rubber or resin. In concrete, rubber compositions comprising polyurethane, silicone rubber, butadiene rubber, isoprene rubber, chloroprene rubber, styrene-butadiene rubber, ethylene-propylene rubber, polynorbornane rubber, styrene-butadiene-styrene rubber, epichlorohydrin rubber or the like as a base rubber may be mentioned as examples, in which polyurethane is particularly preferable, and polyurethane foam is further preferable for use. In this case, the expansion coefficient of the polyurethane foam is not specifically limited, and is preferably 1.2 to 50 times, particularly about 1.5 to 10 times, and the density of the foam is suitably about 0.1 to 0.7 g/cm³.

A conductive agent may be added to the elastic layer 2 to afford or control conductivity so as to obtain a predetermined resistance value. The conductive agent is not specifically limited, and may include cationic surface active agents such as quaternary ammonium salts such as perchlorates, chlorates, hydroborofluorides, sulfates, ethosulfates, benzylhalides such as benzylbromides, benzylchlorides and the like of lauryl trimethylammonium, stearyl methylammonium, octadodecyl trimethylammonium, hexadodecyl trimethylammonium and modified fatty acid-dimethylethylammonium; anionic surface active agents such as aliphatic sulfonates, higher alcohol sulfates, higher alcohol ethylene oxide added sulfates, higher alcohol phosphates, higher alcohol ethylene oxide added phosphates and the like; charging-preventive agents such as nonionic charging-preventive agents such as higher alcohol ethylene oxides, polyethylene glycol fatty acid esters, polyvalent alcohol fatty acid esters and the like; electrolytes such as metallic salts of Group I elements such as Li⁺, Na⁺ and K⁺, such as NaClO₄, LiAsF₆, LiBF₄, NaSCN, KSCN, NaCl and the like, or salts of NH₄⁺ and the like; conductive carbon such as Ketchen Black, acetylene black and the like; carbon for rubber such as SAF, ISAF, HAF, FEF, GPF, SRF, FT, MT and the like; oxidation treated color (ink) carbon, pyrolyzed carbon, natural graphite, artificial graphite; metals and metallic oxides such as anthimony-doped tin oxide, titanium oxide, zinc oxide, nickel, copper, silver, germanium and the like; and conductive polymers such as polyaniline, polypyrrole, polyacetylene and the like. In this case, the amount of the conductive agent blended is appropriately selected according to the kind of the composition, and is generally controlled so that the volume resistivity of the elastic layer becomes 10⁰ to 10⁸ Ω·cm, preferably 10² to 10⁶ Ω·cm.

In addition to the conductive agent, known additives such as thickner, anti-foaming agent, leveling agent, dispersant, thixotropy-adding agent, wetting agent, anti-blocking agent, crosslinking agent, film formation assistant and the like may be added to the elastic layer 2 in appropriate amounts, as required.

The thickness of the elastic layer 2 is appropriately set according to the form and size of the member, layer constitution and the like, and is not specifically limited. In the case of the roller form charging member as shown in FIG. 1, the thickness is preferably set to be ordinarily 1 to 10 mm, particularly about 2 to 5 mm.

The resistance regulation layer 3 formed on the elastic layer 2 is formed of a resin composition prepared by adding a conductive agent to a low-resistance resin matrix having a volume resistivity of 1×10⁴ to 1×10¹⁰ Ω·cm. The low-resistance resin matrix constituting the resin composition may be any one that has the above-mentioned volume resistivity, and is not specifically limited. Concrete examples include urethane resin, acrylurethane resin, acrylic resin, ester resin, nylon resin, phenol resin, epoxy resin, fluororesin, silicone resin and the like, of which one or more in mixture may be used, and particularly preferable ones are water-based resins such as urethane resin, acrylurethane resin and acrylic resin. A more preferable resistance value of the low-resistance resin matrix is 1×10⁵ to 1×10⁸ Ω·cm.

The conductive agent added to the low-resistance resin matrix is an ion conductive substance having a molecular weight of 30 to 800, preferably 100 to 500. Examples of the ion conductive substance include organic ion conductive substances such as perchlrorates, chlorates, hydrochlorides, hydrobromides, hydriodides, hydroborofluorides, sulfates, alkylsulfates, carbonates, sulfonates and the like of ammonium such as tetraethylammonium, tetrabutylammonium, dedecyl trimethylammonium such as lauryl trimethylammonium, hexadecyl trimethylammonium, octadecyl trimethylammonium such as stearyl trimethylammonium, benzyl trimethylammonium, benzyl triethylammonium, benzyl tributylammonium, modified aliphatic dimethylethylammonium and the like; and inorganic ion conductive substances such as perchlorates, chlorates, hydrochlorides, hydrobromides, hydriodides, hydroborofluorides, trifluoromethylsulfates, and sulfonates of alkali metals or alkaline earth metals such as lithium, sodium, calcium, magnesium, and the like, of which one or more may be used. Among these substances, though not specifically limited, one or more of perchlorates of quaternary ammonium may be particularly preferably used.

The resistance regulation layer 3 is for controlling the electrical resistance value of the charging member, and the resistance value of the resistance regulation layer 3 is appropriately set according to the resistance value of the elastic layer 2 and the resistance value required for the member to have, and is generally 1×10³ to 1×10⁸ Ω·cm, particularly 1×10⁵ to 1×10⁷ Ω·cm. In this case, the amount of the ion conductive substance blended as the conductive agent is set to be an appropriate amount to attain the resistance value, and is preferably set to be ordinarily 0.1 to 20 parts by weight, particularly 1 to 10 parts by weight per 100 parts by weight of the low-resistance resin matrix. In the first-named invention, since the low-resistance resin matrix is used as the base resin of the resistance regulation layer 3, the resistance regulation layer 3 having the above appropriate resistance value can be easily obtained by blending such a comparatively small amount of the conductive agent.

In addition to the ion conductive substance, appropriate additives may be added to the resistance regulation layer 3 in such ranges as not to depart from the purpose of the first-named invention, in appropriate amounts according to the low-resistance resin matrix using a crosslinking agent based on, for example, oxazoline, epoxy, melamine, guanamine, isocyanate, phenol or the like. In addition, known additives such as film formation assistant, dispersant, thickner, leveling agent, thixotropy-adding agent, structural viscosity adding agent and the like may be blended in appropriate amounts in such a range as not to depart from the purpose of the resistance regulation layer 3.

The thickness of the resistance regulation layer 3 is appropriately set according to the thickness of the elastic layer 2, the form of the charging member and the like, is not specifically limited, and is preferably set to be ordinarily 10 to 500 μm, particularly 50 to 200 μm. If the thickness is less than 50 μm, it may be difficult to sufficiently control the resistance value; on the other hand, if the thickness is more than 300 μm, the thickness of the elastic layer is comparatively smaller to lead to too high a roller hardness (member hardness), thereby raising the cost excessively.

The method of forming the resistance regulation layer 3 is not specifically limited, and may be a known method such as a dipping method, a spraying method, an extrusion method and the like. Ordinarily, a method of applying to the elastic layer 2 by a dipping method, a spraying method or the like using a coating material solution prepared by dispersing or dissolving the low-resistance resin matrix, the ion conductive substance and other additives is preferably used. Particularly, the dipping method is preferably used.

Next, as a material for forming the skin layer 4, known rubbers or resins used for forming a skin layer of a charging member may be used. Though not specifically limited, examples include urethane-modified acrylic resin, polyurethane resin, acrylic resin, polyamide resin, fluororesin and the like, of which one or more in mixture may be used. Among these materials, fluororesin is particularly preferably used, and by using the fluororesin, good low friction property and toner adhesion property (non-adhesion property) can be achieved.

Concrete examples of the fluororesin include polytetrafluoroethylene, tetrafluoroethylene-perfluoroalkyl vinyl ether copolymer, tetrafluoroethylene-ethylene copolymer, polychlorotrifluoroethylene, chlorotrifluoroethylene-ethylene copolymer, tetrafluoroethylene-vinylidene fluoride copolymer, polyvinylidene fluoride, polyvinyl fluoride and the like.

Though not specifically limited, a conductive agent may be added to the resin forming the skin layer 4 to afford or control the conductivity (electrical resistance) of the skin layer. In this case, as the conductive agent, though not specifically limited, a variety of electron conductive agents and a variety of ion conductive agents may be used. In the first-named invention, carbon can be used particularly preferably.

The amount of the conductive agent added may be appropriately controlled so as to obtain a desired resistance. In this case, the resistance of the skin layer 4 in terms of volume resistivity is preferably 1×10⁴ to 1×10¹² Ω·cm, particularly 1×10⁶ to 1×10⁸ Ω·cm. The amount of the conductive agent added can be controlled so as to achieve such a volume resistivity. The amount of the conductive agent added in the case of using carbon as the conductive agent is ordinarily 1 to 100 phr relative to the base resin, particularly about 10 to 70 phr.

In addition, additives such as crosslinking agent, thickner, thixotropy adding agent and structural viscosity adding agent may be added to the resin composition for forming the skin layer, as required.

The method of forming the skin layer 4 is not specifically limited. Ordinarily, a method of preparing a coating material solution by dispersing or dissolving the resin component, the conductive agent and the like, applying the coating material solution to the resistance regulation layer by a dipping method, a spraying method, a roll coater method or the like, and drying and solidifying the applied coating material is adopted, and particularly, the dipping method is preferably used. The solvent in preparation of the coating material solution is appropriately selected according to the kind of the base resin constituting the resin composition and the like. For example, where a fluororesin is used as the base resin, methyl ethyl ketone (MEK), methyl isobutyl ketone (MIBK), toluene, xylene and the like is preferably used.

The thickness of the skin layer 4 is set according to the form of the charging member and the like, and is not specifically limited. For example, in the case of the roller form charging member as shown in FIG. 1, the thickness may be ordinarily 1 to 30 μm, particularly 1 to 20 μm. If the thickness is less than 1 μm, durability of the roller may be insufficient; on the other hand, if the thickness is more than 20 μm, bad effects may be exerted on charging characteristics, and good surface properties cannot be obtained because of generation of wrinkles on the surface or the like.

While the charging member according to the first-named invention comprises the resistance regulation layer 3 and the skin layer 4 provided on the elastic layer 2, other layer may be intermediately provided between the elastic layer 2 and the resistance regulation layer 3 or between the resistance regulation layer 3 and the skin layer 4. For example, an adhesive layer with a thickness of 1 to 50 μm can be provided between the elastic layer 2 and the resistance regulation layer 3 in order to achieve rigid adhesion of the two layers. In this case, the adhesive layer may be formed by applying a coating material containing a resin material such as, for example, acrylic resin, urethane resin, acrylurethane resin, polyester resin, polyamide resin and the like to the elastic layer 2 by a dipping method or the like, and a conductive agent and other additives may be added to the coating material as required.

Here, for the formation of the resistance regulation layer 3, the skin layer 4 and the adhesive layer or the like, a method of applying a coating material by a dipping method and drying the coating material to form a film is preferably adopted. The goodness or badness of the film-forming operation by the dipping method has a large influence on the uniformity of each layer and the like, and this has a large influence on the performance of the charging roller obtained. Therefore, it is important to securely obtain a good film formation condition by severe control of the temperature conditions and drying conditions at the time of forming each layer.

Namely, in the case of forming the resistance regulation layer 3, the skin layer 4 and the adhesive layer or the like by the dipping method, generally industrially, 30 or more rollers are hung vertically, simultaneously dipped in the coating material, drawn upward, and the coating material is dried by blowing air. In this case, in order to obtain good film formation conditions, it is important to severely control the temperature of the coating material at the time of application of the coating material and to severely control the air-blowing conditions at the time of drying.

In concrete, as to the control of the coating material temperature, a bath for dipping is provided with a heater and a temperature sensor, and the coating material temperature at the time of coating is preferably kept substantially at a fixed temperature in the range of 25 to 35° C. More concretely, the coating with the coating material by dipping is preferably conducted while keeping the coating material within ±1° C. in the above-mentioned temperature range. As to the temperature control of the rollers, all the rollers immediately before immersion are preferably controlled to be at a substantially uniform temperature by use of a heater or a hot air flow. More concretely, it is preferable to heat the rollers to a temperature of not lower than 30° C. and set the dispersion of the roller temperature to within ±1° C. of the average temperature of all rollers. Further, as to the air-blowing conditions, it is preferable to conduct drying by blowing air to the plurality of rollers hung from a hanger, from the lower side toward the upper side; more preferably, it is preferable to control the dispersion of velocity of airflow at each portion of all the rollers to within ±0.1 m/s. By the coating material temperature control, the roller temperature control and the air-blowing condition control, it is possible to achieve good formation of the resistance regulation layer 3, the skin layer 4 and the adhesive layer or the like, without liquid sag or film formation of the coating material and without generation of bubbles.

The coating material temperature control, the roller temperature control and the air-blowing condition control may, more concretely, be conducted according to the manufacturing methods of the second-named to fourth-named inventions described below, and formation of the coating films by the dipping method may be conducted by an appropriate combination of the manufacturing methods of the second-named to fourth-named inventions.

The charging member according to the first-named invention is disposed in the condition of making contact with the body to be charged such as a photosensitive body, and a voltage is impressed between the body to be charged and the charging member of the present invention, whereby the body to be charged is charged. In this case, the voltage impressed between the charging member and the body to be charged is preferably only a DC voltage. In the first-named invention, even where the charging operation is conducted by impressing only a DC voltage, the problems of bleeding of the conductive agent, environment dependency or the like are not generated, there is little voltage dependency, and the charging member can be preferably used in a charging system of impressing only a DC voltage.

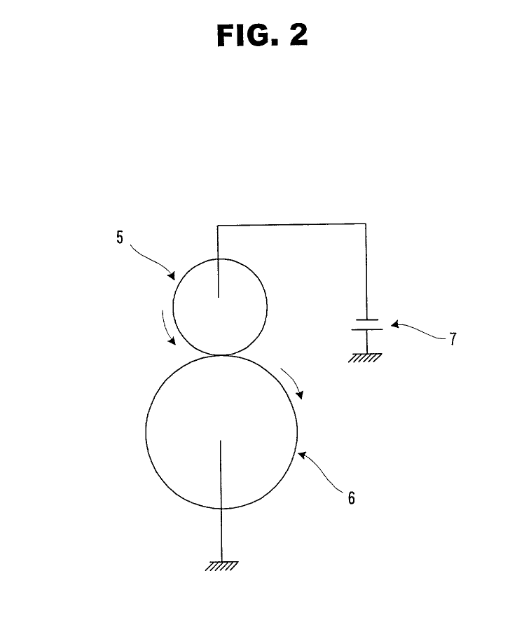

As the charging device using the charging member according to the first-named invention, there may be mentioned, for example, as shown in FIG. 2, a charging device in which the charging member 5 of the first-named invention is brought into contact with the body to be charged 6 such as a photosensitive body at a predetermined pressure, and a DC voltage supplied from a voltage impressing means 7 is impressed between the charging member 5 and the body to be charged 6. However, this is not limitative, and the forms of the body to be charged 6 and the charging member 5 and the voltage impressing system by the voltage impressing means 7 may be modified appropriately.

The charging member according to the first-named invention can provide a charging member having little voltage dependency and free of the problems such as bleeding of the conductive agent, environment dependency and the like, and can be preferably used in the charging system of impressing only the DC voltage. Therefore, according to the charging device using the charging member of the first-named invention, favorable charging can be performed by impressing only the DC voltage.

### Second-named to Fourth-named Inventions

The methods of manufacturing a charging roller according to the second-named to fourth-named inventions all comprise the step of dipping the rollers in a coating material to form a coating film on the surface of each roller. In the second-named invention, the temperature of the coating material at the time of the dipping treatment is appropriately controlled; in the third-named invention, the temperatures of the rollers at the time of the dipping treatment are appropriately controlled; and in the fourth-named invention, the air-blowing conditions are appropriately controlled in the case of blowing air to a plurality of rollers provided on their surfaces with coating films by the dipping treatment to thereby dry the coating films.

In the manufacturing methods according to the second-named to fourth-named inventions, as the resin for constituting the coating films provided on the surfaces of the rollers, a crosslinking resin is preferable. Here, the crosslinking resin means a resin capable of self-crosslinking under heat, catalyst, air, moisture, electron beams or the like, or a resin capable of crosslinking through reaction with a crosslinking agent or other crosslinking resin.

Concrete examples of the crosslinking resin include fluororesin, polyamide resin, acrylic resin, alkyd resin, phenol resin, melamine resin, silicone resin, epoxy resin, polyether resin, amino-resin, urea resin and mixtures thereof. Particularly, alkyd resin, phenol resin, melamine resin and mixtures thereof are excellent in view of non-contamination property for the rollers and keeping of anti-abrasion property.

A catalyst and a crosslinking agent are added to the crosslinking resin, as required. As the catalyst, there may be mentioned radical catalysts such as peroxides, base catalysts, acid catalysts and the like. As the crosslinking agent, there may be mentioned polyol compounds, polyisocyanate compounds, polyaldehyde compounds, polyamine compounds, polyepoxy compounds and the like.

In the manufacturing methods according to the second-named and third-named inventions, the coating material used for the dipping treatment is not specifically limited, is appropriately selected according to the kind of the coating film, and a coating material prepared by dissolving the crosslinking resin and the like in a solvent is used. Particularly, the effects of the inventions are conspicuously displayed in the case of using a water-based coating material. This is because in the case of a water-based coating material, the liquid sag of the coating material causes a problem in the dipping treatment of the rollers, and, accordingly, the significance of using the manufacturing methods of the second-named to fourth-named inventions is great. Incidentally, a coating material excellent in drying property such as oil-based coating materials does not generate the liquid sag problem as compared with the case of using the water-based coating material, but the significance of using the second-named to fourth-named inventions is sufficiently present.

As the water-based coating material, though not specifically limited, any of urethane coating materials, acrylic coating materials and emulsion coating materials is preferably used; when the water-based coating material is used, the effects of carrying out the second-named to fourth-named inventions are great.

In the case of using an oil-based coating material, the solvents which can be used in preparation of the coating material include alcoholic solvents such as methanol, ethanol, isopropanol, butanol and the like, ketone solvents such as acetone, methyl ethyl ketone and the like, aromatic hydrocarbon solvents such as toluene, xylene and the like, aliphatic hydrocarbon solvents such as hexane, ester solvents such as ethyl acetate, ether solvents such as isopropyl ether, and mixtures thereof.

It is preferable that the roller coated with the coating material is provided with an elastic layer composed of solid rubber or urethane rubber or a foamed body such as urethane foam, in view of formation of images, and one or a plurality of coating films can be provided on the elastic layer by the second-named to fourth-named inventions.

In the case where the charging roller is electrically conductive, a conductive agent can be added to the coating material for forming the elastic layer or a coating film.

The conductive agents include ion conductive agents and electron conductive agents. As the ion conductive agent, there may be mentioned organic ion conductive agents such as perchlorates, chlorates, hydrochlorides, hydrobromides, hydriodides, hydroborofluorides, sulfates, alkylsulfates, carbonates, sulfonates and the like of ammonium such as tetraethylammonium, tetrabutylammonium, dodecyl trimethylammonium such as lauryl trimethylammonium, hexadecyl trimethylammonium, octadecyl trimethylammonium such as stearyl trimethylammonium, benzyl trimethylammonium, modified aliphatic dimethylethylammonium and the like; and inorganic ion conductive agents such as perchlorates, chlorates, hydrochlorides, hydrobromides, hydriodides, hydroborofluorides, trifluoromethylsulfates, sulfonates and the like of an alkali metal or alkaline earth metal such as lithium, sodium, calcium and magnesium, and the like.

As the electron conductive agent, there may be mentioned conductive carbon black such as Ketchen Black, acethylene black and the like; carbon black for rubber such as SAF, ISAF, HAF, FEF, GPF, SRF, FT, MT and the like; carbon black for ink such as oxidized carbon black and the like; pyrolyzed carbon black; graphite; conductive metallic oxides such as tin oxide, titanium oxide, zinc oxide and the like; metals such as nickel, copper and the like; conductive whisker such as carbon whisker, graphite whisker, titanium carbide whisker, conductive potassium titanate whisker, conductive barium titanate whisker, conductive titanium oxide whisker, conductive zinc oxide whisker, and the like.

Where a foamed body is used as the elastic layer on the roller and the material of the foamed body is polyurethane or the like, in addition to the conductive agent, there may be added fillers such as inorganic carbonates, foam stabilizers such as silicone foam stabilizer and various surface active agents, antioxidants such as phenol and phenylamine, friction-lowering agents, charge-controlling agents and the like.

As the foam stabilizer, dimethylpolysiloxane-polyhydroxyalkylene copolymer and the like may be preferably used, among which particularly preferred is one composed of a dimethylpolysiloxane moiety having a molecular weight of 350 to 15000 and a polhydroxyalkylene moiety having a molecular weight of 200 to 4000. In this case, the molecular structure of the polyhydroxyalkylene moiety is preferably an addition polymer of ethylene oxide or a co-addition polymer of ethylene oxide and propylene oxide, preferably terminated with ethylene oxide.

As the surface active agent, there may be mentioned cationic surface active agents, anionic surface active agents, and amphoteric ionic surface active agents, and nonionic surface active agent such as polyethers, polyesters and the like.

In order to produce the elastic layer of the charging roller with a foamed body as a material, a mechanical froth method, a water foaming method, a foaming agent froth method and the like may be adopted. In the present invention, the mechanical froth method is preferably used.

In order to produce a foamed body roller by the mechanical froth method, a foam body material foamed by mechanical stirring is poured into a preheated mold cylindrical in inner surface form in which a shaft made of a metal or the like is disposed, and reaction and curing are caused, or a foamed body material is poured into a mold, and reaction and curing are caused while mixing an inert gas into the material and applying mechanical stirring.

Here, the inert gas used in the mechanical froth method, for example in the case of polyurethane reaction, any gas inert to the polyurethane reaction may be used. As the gas usable, there may be mentioned not only the narrow-meaning inert gas such as helium, argon, xenon, radon, krypton, and the like but also gases not reactive with polyisocyanate such as nitrogen, carbon dioxide, dry air and the like.

The method of manufacturing a charging roller according to the second-named invention is such that, in the case of dipping the rollers provided with the elastic layer in the coating material to form a coating film, the dipping treatment is conducted while keeping the coating material at a substantially fixed temperature at a predetermined temperature in the range of 25 to 35° C.

In order to keep the coating material at a fixed temperature, a heater or the like is disposed at a lower portion on the inside or outside of a bath for dipping, and temperature control is conducted by a known method while supervising the coating material temperature by a sensor or the like. Alternatively, a hot water circulating passage is provided in the outer wall or bottom wall of a tank, and hot water is circulated in the passage, thereby heating the coating material.

In addition, in the method of manufacturing a charging roller according to the second-named invention, not only the temperature is kept in the range of 25 to 35° C., but also the temperature is kept at a substantially uniform predetermined temperature in the range of 25 to 35° C. while the dipping treatment is conducted. In this case, in order to manufacture a charging roller with higher quality, and in the case where the drying property of the coating material varies according to the temperature of the coating material, it is preferable to control the temperature of the coating material within ±1° C. of the predetermined temperature in the temperature range. In this case, when the variation width of the temperature of the coating material exceeds ±1° C., it may be difficult to prevent the coating material sag, according to the kind of the coating material, and defective product may be generated.

Here, in the second-named invention, as above-mentioned, the coating material temperature at the time of the dipping treatment is kept constant at a predetermined temperature in the range of 25 to 35° C., and the predetermined temperature is set at an appropriate temperature selected in the range of 25 to 35° C. according to the kind of the coating material used and the lowering and raising process conditions for the rollers at the time of dipping. The lowering and raising process conditions for the rollers means the following conditions. Namely, the conditions are lowering speed, immersion time, raising speed and the like at the time of lowering the rollers hung from a hanger or the like disposed on the upper side of the coating material bath, thereby immersing the rollers in the coating material and, after the lapse of a predetermined period of time, raising the rollers out of the coating material.

In this case, as for the temperature control of the coating material, not only the coating material temperature must be kept constant while the rollers are immersed in the coating material and are pulled up, but also the coating material temperature must be kept constant while the dipping treatment is repeated, in the case where the dipping treatment is successively repeated for a plurality of rollers. Namely, the dipping treatment for the rollers is usually conducted simultaneously for a plurality of rollers by hanging the plurality of rollers from a hanger (industrially, the dipping treatment is conducted simultaneously for 30 or more rollers), and, by successively repeating the dipping treatment for, for example, 30 rollers to thereby efficiently performing the dipping treatment. At this time, the lowering and raising process conditions are not controlled for each dipping cycle, from the reason on a production efficiency basis, and the dipping treatment is repeated under fixed lowering and raising process conditions. According to the second-named invention, the coating material temperature is kept constant as above-mentioned while the dipping treatment is repeated, in the case where the dipping treatment is successively repeated.

Next, the method of manufacturing a charging roller according to the third-named invention is a method in which, in the case of dipping a plurality of rollers provided with the elastic layers in the coating material to simultaneously form coating films on the surfaces of the plurality of rollers, the temperatures of the plurality of rollers immediately before the dipping are kept to be substantially uniform over all the rollers, and it is preferable that the temperature of each individual roller is substantially uniform over the entire body of the roller.

As a method of controlling the plurality of rollers at a fixed temperature immediately before the step of dipping the rollers in the coating material, there may be preferably adopted a method in which the rollers immediately before the dipping step are preheated by use of a heater or hot airflow. In this case, it is preferable to uniformly preheat the rollers to a temperature of not lower than 30° C.

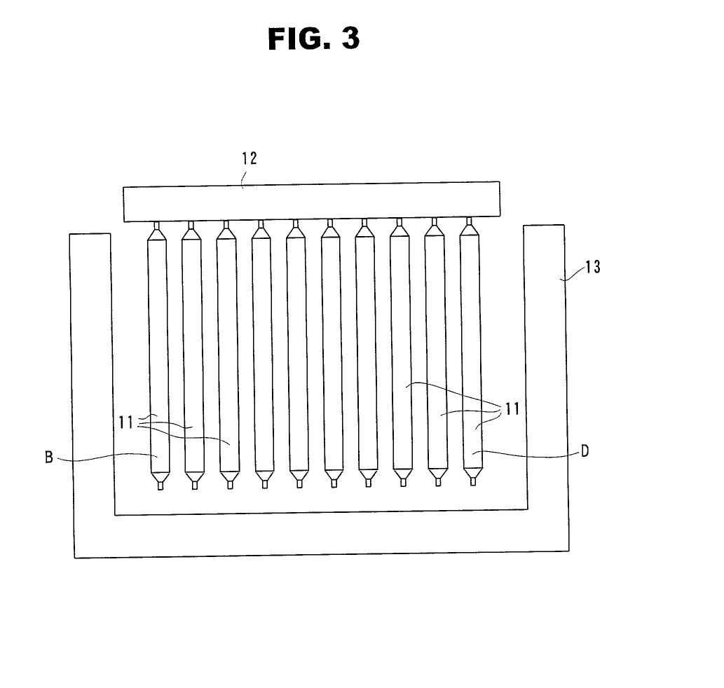

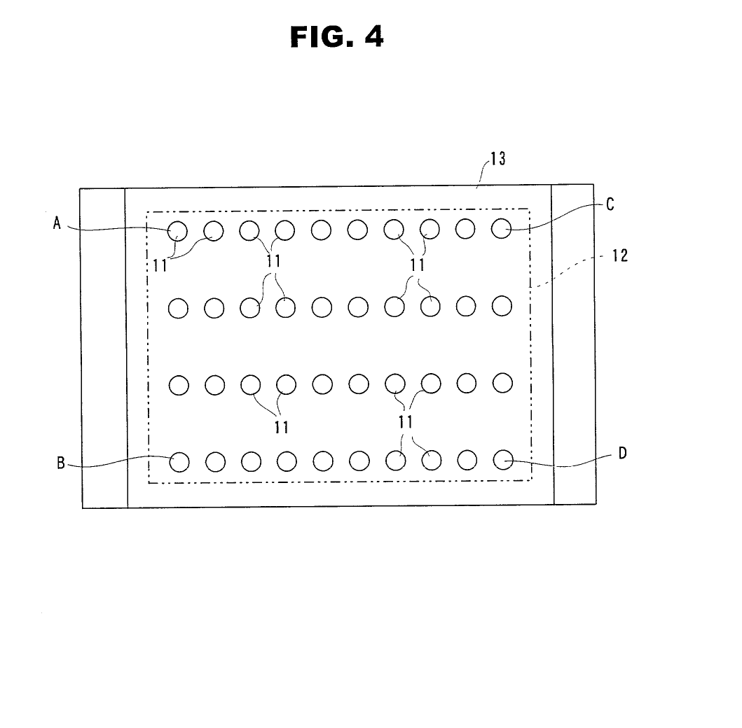

More concretely, as for example shown in FIGS. 3 and 4, a plurality (40, in the figure) of rollers 11 as a unit may be hung from the hanger 12 in a vertical condition and at regular intervals, and may be heated in a roughly U-shaped heating device 13 provided with heaters at a bottom surface and both side surfaces. In this case, it is preferable to provide temperature sensors (not shown) at several positions on the inside of the heating device 12, and to control the heaters so that all the rollers are heated to a uniform temperature.

In the case of preheating the rollers by hot airflow, in order to prevent the hot airflow from concentratedly colliding against a part of the outer peripheral surface of each individual roller, it is preferable to feed the hot airflow at a low velocity and to set a large interval between adjacent rollers. By such arrangement, the temperature distribution in the axial direction and the circumferential direction of each roller is made to be uniform.

In addition, deviations of temperature distribution in the axial direction of the rollers hung from a hanger can be coped with to a certain extent by controlling the dipping speed at the time of dipping. Therefore, it is more important to make substantially uniform the temperature distribution at the same height of the multiplicity of rollers hung from the hanger, than to ensure temperature uniformity in the axial direction of the rollers. By the substantially uniform temperature distribution at the same height, it is possible to perform the dipping treatment while controlling all the rollers at a substantially uniform temperature.

As another method of preheating the rollers to a uniform temperature, there may be a method in which the production steps are improved and it is ensured that no roller is in a stand-by condition between the drying step and the dipping step. Namely, where the rollers coming out of the drying step is then subjected to the dipping treatment, the next unit of rollers are made to stand by in the drying furnace. By such arrangement, when the temperature in the drying furnace is controlled, the rollers can be heated to the temperature stably and uniformly.

The preheating temperature for preheating the rollers is preferably not lower than 30° C., as mentioned above. The preheating temperature is appropriately set at a predetermined temperature not lower than 30° C., according to the material of the rollers, the kind of the coating material, the lowering and raising process conditions for the rollers, and the like.

Thus, according to the manufacturing method of the third-named invention, the temperatures of the plurality of rollers immediately before being simultaneously subjected to the dipping treatment are controlled to be substantially uniform. In this case, the dispersion of roller temperature is not specifically limited, and is preferably within ±1° C. of the average of all roller temperatures. With such arrangement, coating material sag can be securely prevented, generation of defective products can be more securely prevented, and coating films with high accuracy can be securely formed. Particularly where extremely high performance of the charging roller is required, it is very important to restrict the temperature dispersion to within ±1° C.

Next, the method of manufacturing a charging roller according to the fourth-named invention is such that, in the case of dipping the rollers provided with the elastic layers in the coating material to apply the coating material to the surfaces of the rollers and drying the coating material on the rollers, the plurality of rollers provided on their surfaces with the coating films by the dipping treatment are hung substantially vertically, and air is blown from the lower side toward the upper side of the rollers to thereby dry the coating films.

As a method of blowing air from the lower side to the plurality of rollers hung vertically, there may be preferably used a method in which the plurality of rollers are hung from a hanger, an air-blowing chamber for feeding airflow at a uniform velocity is disposed on the lower side of the rollers, and air is blown from the lower side toward the upper side.

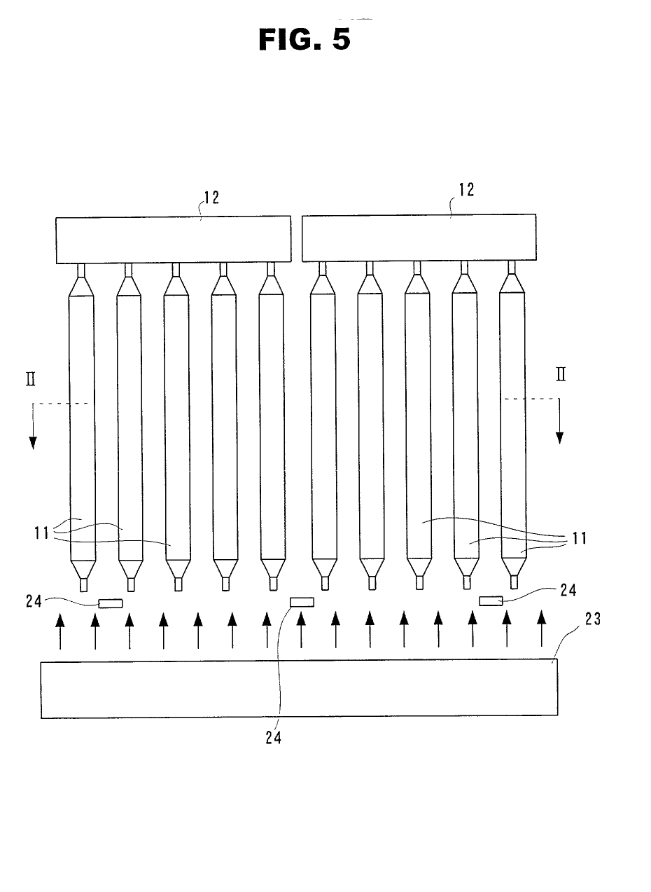

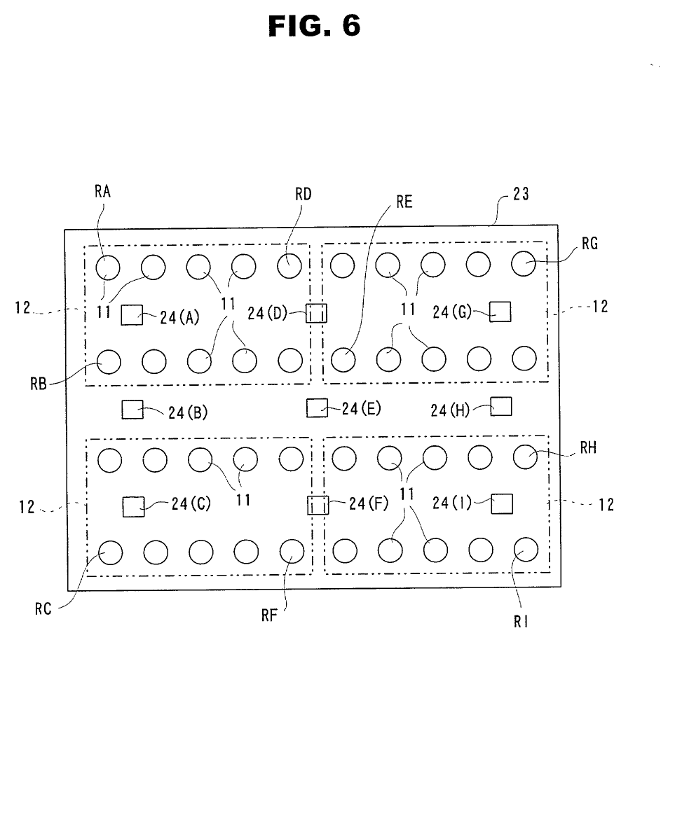

More concretely, as for example shown in FIGS. 5 and 6, a plurality (40, in the figure) of rollers 11 are vertically hung from the hangers 12 arranged in a matrix form so that the rollers 11 are arranged at regular intervals in a matrix form, an air-blowing chamber 23 having a multiplicity of air feed ports (not shown) is disposed on the lower side of the rollers 11, and airflows jetted out from the air-blowing chamber 23 are blown to all the rollers 11 from the lower side as uniformly as possible, thereby drying the coating material on the surfaces of the rollers 11.

Here, as the air-blowing chamber 23, for example, one comprising baffle plates or filters disposed on the upper side of a simple fan-type upward blower can be used, or one comprising a multiplicity of small-type blowers can be used, whereby uniform airflows can be fed through the air feed ports. In this case, it is desirable to measure and control the air velocity by use of a plurality of sensors 24 and the like, as shown in FIGS. 5 and 6.

In addition, since it is necessary to uniformly blow the airflows against all the rollers 11 hung from the hangers 12, it is preferable that the air-blowing chamber 24 is as large as possible, or it is preferable that a multiplicity of small-type air-blowing chambers are used. In the case of providing a multiplicity of small-type air-blowing chambers, it is preferable to use at last one air-blowing chamber per five rollers, though it depends on the size of the rollers and the like. With such arrangement, the blowing of the airflows against each portion of the rollers 11 is made substantially uniform, and the time required for drying and the degree of drying of each portion of the rollers can be made substantially constant.

Here, according to the manufacturing method of the fourth-named invention, air is blown from the lower side to the rollers vertically hung from the hanger or the like to dry the coating material on the rollers. In this case, it is important to uniformly blow the airflow onto the entire surface of each roller. In concrete, it is preferable to feed the airflow at a predetermined velocity of not more than 1.5 m/s and to set the dispersion of the velocity of the airflow colliding against each portion of the roller to within ±0.1 m/s (or within ±10%). More specifically, it is preferable to maintain the velocity of airflow colliding against each portion of the roller to within the range of 0.9 to 1.1 m/s. In this case, if the velocity of the airflow is too high, drying proceeds too fast, resulting in an incompletely dried condition where a film is formed only at the surface of the coating material. On the other hand, if the velocity of the airflow is too low, drying proceeds too partially, possibly resulting in the so-called liquid sag condition where the coating material flows down and collects at a lower portion of the vertically disposed roller.

As above-mentioned, the manufacturing methods according to the second-named to fourth-named inventions are characterized in that, in the case of dipping rollers in a coating material to form coating films on the surfaces of the rollers, the temperature of the coating material at the time of the dipping treatment is appropriately controlled (second-named invention), the temperatures of the rollers are appropriately controlled (third-named invention), or the air-blowing conditions at the time of drying the coating films are appropriately controlled (fourth-named invention). According to the manufacturing methods of the second-named to fourth-named inventions, a charging roller with high quality can be obtained securely and stably, without generating defects on a production basis such as sag of the coating material and unevenness of coating film thickness.

### EXAMPLES

Now, the first-named to fourth-named inventions will be described in concrete by giving examples on the basis of each of the first-named to fourth-named inventions.

### First-named Invention

### Examples 1 to 3, and Comparative Examples 1 to 3

A polyurethane foam prepared by adding carbon to a polyester polyol and isocyanate and having a density of 0.55 g/cm³ was molded on the outer periphery of a metallic shaft 1 to form an elastic layer in a thickness of 3 mm, thereby obtaining a polyurethane foam roller.

The roller was dipped in a coating material solution having a resin concentration of 10% prepared by adding a conductive agent to a water-based coating material (urethane resin), followed by drying, to form an adhesive layer in a thickness of 10 μm. The roller was then dipped in a coating material solution prepared by adding a conductive agent to a water-based coating material shown in Table 2 below so as to have a resin concentration of 50%, followed by drying, to form a resistance regulation layer in a thickness of 120 μm on the adhesive layer. Further, a skin layer in a thickness of 5 μm was formed by a dipping method using a coating material solution (for forming the skin layer) prepared by adding carbon to a tetrafluoroethylene-perfluoroalkyl vinyl ether copolymer resin and dispersing and dissolving the admixture in a methyl ethyl ketone solvent, to obtain a roller form charging roller.

In this case, temperature control for the coating material solution and the roller at the time of forming the adhesive layer, the resistance regulation layer and the skin layer was conducted as shown in Table 1 below, air was blown from the lower side toward the upper side of the roller at the time of drying, and the velocity of airflow at the time of drying was controlled as shown in Table 1 below.

TABLE 1

| | Temp. of | | |
|---|---|---|---|
| | Coating | Temp. of | Air-blowing |
| | Material | Roller | Condition |
| Adhesive layer | 27° C., ±1° C. | 35° C., ±1° C. | 0.1 m/s, ±0.05 m/s |
| Resistance | 27° C., ±1° C. | 35° C., ±1° C. | 0.1 m/s, ±0.05 m/s |
| regulation layer | | | |
| Skin layer | 25° C., ±1° C. | 30° C., ±1° C. | 0.1 m/s, ±0.05 m/s |

For each charging roller thus obtained, bleeding of the conductive agent, durability, resistance, voltage dependency and charging uniformity (image) were evaluated by the following methods. The results are shown in Table 2.

### Bleeding of Conductive Agent

A severe storage test of leaving the roller under high temperature and high humidity (45° C., 90% RH) in the condition of making contact with a photosensitive body, and the case where nothing was transferred onto the photosensitive body was evaluated to be ◯, and the case where fogging or the like is present on the photosensitive body was evaluated to be X.

### Durability

A fixed voltage of DC-200 V was impressed under low temperature and low humidity (15° C., 10% RH), and time change of the roller resistance was measured; the case where the rise in resistance from the initial resistance value is within 30% was evaluated to be ◯, and the case where the rise in resistance is more than 30% was evaluated to be X.

### Environment Dependency

A fixed voltage of DC-200 V was impressed under high temperature and high humidity (45° C., 90% RH) and under low temperature and low humidity (15° C., 10% RH), and resistance values under the two environments were compared with each other. The case where the difference between the two resistance values is within 10 fold was evaluated to be ◯, and the case where the difference is more than 10 fold was evaluated to be X.

### Voltage Dependency

Each of DV voltages of 50 V and 150 V was impressed, and the current flowing at that time was measured. The case where the value of (measured value at 150 V)/(measured value at 50 V) is less than 8 was evaluated as “voltage dependency is present”, and the case where the value is not less than 8 was evaluated as “voltage dependency is absent”.

### Charging Uniformity (Image)

Each roller was actually mounted on a laser beam printer, and image evaluation was conducted under high temperature and high humidity (45° C., 90% RH) and under low temperature and low humidity (15° C., 10% RH). The case where the image is free of any problem was evaluated to be ◯, and the case where the image has fine streak patterns was evaluated to be X.

TABLE 2

| | | Composition of | | | | | | |
|---|---|---|---|---|---|---|---|---|
| | | resistance | | | | | | |
| | | regulation layer | | Performance of charging member | | | | |
| | | (parts by weight) | | | | | | Charging |
| | | Resin | Conductive | | | Environment | Voltage | uniformity |
| | | matrix | agent | Bleed | Durability | dependency | dependency | (image) |
| Comp. Ex. | 1 | A(100) | MA100(20) | ◯ | ◯ | ◯ | present | X |
| | 2 | A(100) | NaClO₄(20) | X | X | X | absent | X |
| | 3 | A(100) | MA100(20) | ◯ | ◯ | ◯ | present | X |
| Example | 1 | B(100) | NaClO₄(1) | ◯ | ◯ | ◯ | absent | ◯ |
| | 2 | B(100) | BTEAC (5) | ◯ | ◯ | ◯ | absent | ◯ |
| | 3 | B(100) | BTBAC(10) | ◯ | ◯ | ◯ | absent | ◯ |

Notes:
Resin matrix A: water-dispersed urethane resin; a product by Daiichi Kogyo Seiyaku Co., Ltd.; commercial name “Superflex E2500”; resin resistance 2 × 10¹⁴ Ω · cm.

Resin matrix B: water-dispersed urethane resin; a product by Daiichi Kogyo Seiyaku Co., Ltd.; commercial name “Superflex E2000”; resin resistance 2×10⁷ Ω·cm.

MA100: carbon black; a product by Mitsubishi Chemical Corp. Commercial name “MA100”.

BTEAC: benzyl triethylammonium chloride; a product by Lion Corp.; commercial name “BTEAC”; molecular weight 241.

BTBAC: benzyl tributylammonium chloride; a product by Lion Corp.; commercial name “BTBAC”; molecular weight 313.

As shown in Table 2, according to Examples 1 to 3 in which the resistance regulation layer is formed by use of a resin composition prepared by blending an ion conductive substance having a molecular weight of 30 to 800 as a conductive agent into a low-resistance resin matrix having a resistance of 1×10⁴ to 1×10¹⁰ Ω·cm, a charging member having a predetermined resistance can be obtained without generating the problems as to bleeding of the conductive agent, durability, and voltage dependency. It was confirmed that, by using the charging member in a charging system for charging through impressing only a DC voltage, a photosensitive body (body to be charged) can be uniformly charged, and good images can be obtained.

### Second-named Invention

Examples 4 and 5, and Comparative Examples 4 to 6

An acrylic coating material as a water-based coating material was applied to the surface of a charging roller composed of solid rubber by a dipping treatment.

At this time, as above-mentioned, a heater and sensors or the like were used to keep the temperature of the coating material at the time of dipping to within ±1° C. of each of five temperatures of 23° C., 24° C., 25° C., 35° C. and 36° C., and dipping was conducted under lowering and raising process conditions according to the temperature conditions. At this time, sag of the coating material on the surface of the rollers, and the presence or absence of film formation in the vessel of the coating material was observed. The charging rollers thus obtained were mounted on an image-forming device based on electrophotography, and image tests were conducted. The results are shown in Table 3.

TABLE 3

| | Comparative | Comparative | | | Comparative |
|---|---|---|---|---|---|
| | Example 4 | Example 5 | Example 4 | Example 5 | Example 6 |
| Coating material temp. | 23° C. | 24° C. | 25° C. | 35° C. | 36° C. |
| at the time of dipping | | | | | |
| Liquid sag | present | present | absent | absent | absent |
| Film formation | absent | absent | absent | absent | present |
| Image test | bad | bad | good | good | — |

As shown in Table 3, by controlling the temperature of the coating material to within ±1° C. of 25° C. and 35° C., the coating material is applied uniformly, and a charging roller capable of giving good images can be manufactured. When the temperature of the coating material was 23° C., 24° C., and 36° C., sag of the coating material or film formation was observed.

In addition, 40 charging rollers composed of solid rubber as a set were hung from a hanger, were dipped in a coating material and dried over 15 minutes, and this operation as a cycle was repeated to perform 24 cycles in 6 hours. At this time, the lowering and raising process conditions for the rollers were controlled to be the conditions capable of giving good coating films at the initial coating material temperature, and the fixed conditions were used for all cycles. The variation of the coating material temperature during the 6 hours of dipping treatment was observed, and the properties of the coating films obtained were evaluated. As a result, it was confirmed that when the coating material temperature varies in excess of ±1° C., the ratio of generation of liquid sag is not less than 30%, whereas when the variation is within ±1° C., the ratio can be suppressed to about 2%.

### Third-named Invention

### Examples 6 and 7, and Comparative Examples 7 and 8

An acrylic coating material as a water-based coating material was applied to a substrate of a charging roller composed of urethane foam by a dipping treatment.

In this case, as shown in FIGS. 3 and 4, 40 rollers 11 as a unit were vertically hung from hangers 12 so that 10 rollers each in each of four rows were regularly spaced, the rollers were heated in a roughly U-shaped heating device 13 provided with heaters at the bottom surface and both side surfaces, and immediately thereafter, the rollers were subjected to a dipping treatment. At this time, the temperatures at upper and lower portions of the rollers A, B, C and D disposed at four corners in FIG. 4 immediately before the dipping of the rollers in the coating material after heating were measured. The results of measurement are shown in Table 4.

In addition, the presence or absence of liquid sag, film formation, bubbles and the like at the surfaces of the upper and lower portions of each of the rollers A, B, C and D after the dipping treatment was evaluated. Further, each of the charging rollers A, B, C and D was mounted on an image-forming device based on electrophotography, and image tests were carried out. The results are shown in Table 4.

TABLE 4

| | | | | Comparative | Comparative |
|---|---|---|---|---|---|
| | | Example 6 | Example 7 | Example 7 | Example 8 |
| Roller | | A | B | C | D |
| Roller temp. | Upper portion | 33.7 | 34.3 | 33.8 | 32.3 |
| at the time | Lower portion | 34.2 | 34.2 | 35.5 | 34.1 |
| of dipping | | | | | |
| Liquid sag | Upper portion | absent | absent | absent | present |
| | Lower portion | absent | absent | absent | absent |
| Film | Upper portion | absent | absent | absent | absent |
| formation | Lower portion | absent | absent | present | absent |
| Image test | | good | good | bad | bad |

Note: The average temperature of 8 portions, namely, upper and lower portions of roller A, upper and lower portions of roller B, upper and lower portions of roller C, and upper and lower portions of roller D was 34.0° C..

As shown in FIG. 4, when the roller temperature was deviated from the average by in excess of ±1° C., there occurred some trouble. Namely, when the roller temperature was lower than the average by more than 1° C. (upper portion of roller D), sag of the coating material was observed, whereas when the roller temperature was higher than the average by more than 1° C. (lower portion of roller C), film formation and bubbling of the coating material were observed.

### Fourth-named Invention

### Example 8

An acrylic coating material as a water-based coating material was applied to charging rollers composed of solid rubber by a dipping treatment.

In this case, as shown in FIGS. 5 and 6, 40 rollers 11 were vertically hung from four hangers 12 arranged in a matrix form so that 10 rollers 11 as a unit were arranged in two front and rear rows each having five rollers 11 and all the rollers 11 were arranged at regular intervals in the front-rear and left-right directions. An air-blowing chamber 23 having a multiplicity of air feed ports (not shown) was disposed on the lower side of the rollers 11, and airflows jetted from the air-blowing chamber 23 were blown from the lower side of all the rollers 11 as uniformly as possible at a wind velocity of 1.0 m/s, thereby drying the coating material on the rollers 11. At this time, nine measurement points A to I were set between the front and rear rows of the rollers 11 at substantially regular intervals, and the velocity of airflow impinging on lower portions of the vertically disposed rollers were measured by anemometers 24 disposed at the measurement points A to I. Further, it was observed whether sag of the coating material was present at a part of the rollers 11 and whether a difference in film thickness of the coating films on the surfaces of the rollers 11 was present.

The wind velocities measured at the nine measurement points A to I and the presence or absence of liquid sag and a difference in film thickness in the circumferential direction observed for each of the rollers RA, RB, RC, RD, RE, RF, RG, RH and RI in FIG. 6 are shown in Table 5.

TABLE 5

| Measurement point | A | B | C | D | E | F | G | H | I |
|---|---|---|---|---|---|---|---|---|---|
| Wind velocity (m/s) | 0.9 | 1.0 | 1.0 | 1.0 | 0.8 | 1.0 | 1.0 | 1.1 | 1.2 |
| Roller | RA | RB | RC | RD | RE | RF | RG | RH | RI |
| Liquid sag | absent | absent | absent | absent | present | absent | absent | absent | absent |
| Difference in film thickness | absent | absent | absent | absent | absent | absent | absent | absent | present |
| in circumferential direction | | | | | | | | | |

From the results of Table 5, the followings were found. When the airflow velocity was not more than 0.8 m/s (dispersion −0.2 m/s), the airflow was not sufficiently supplied to an upper portion of the roller 11, so that drying was slow and liquid sag was generated. When the airflow velocity is not less than 1.2 m/s (dispersion +0.2 m/s), the surface of the coating film was dried rapidly but the bulk of the coating film was not sufficiently dried, resulting in an incompletely dried condition in which only the surface of the coating film was dried. In addition, the airflow (wind) generated turbulent flow at an upper portion of the roller, so that rollers unevenly dried at their upper portions and having a variation in the coating film thickness were obtained, in the same manner as in the case of using lateral winds.

1. A charging member for charging a body to be charged by bringing said charging member into contact with said body to be charged and impressing a voltage between said charging member and said body to be charged, wherein
said charging member comprises an elastic layer, a resistance regulation layer provided on said elastic layer, and a skin layer provided on said resistance regulation layer, and said resistance regulation layer is formed from a resin composition prepared by blending an ion conductive substance having a molecular weight of 30 to 800 as a conductive agent in a low-resistance resin matrix having a resistance of 1×10⁴ to 1×10¹⁰ Ω·cm.

2. A charging member as set forth in claim 1, wherein said ion conductive substance is blended in an amount of 1 to 10 parts by weight per 100 parts by weight of said low-resistance resin matrix.

3. A charging member as set forth in claim 1, wherein said low-resistance resin matrix is one or at least two selected from the group consisting of urethane resin, acrylurethane resin and acrylic resin.

4. A charging member as set forth in claim 1, wherein said ion conductive substance is one or at least two selected from the group consisting of cationic surface active agents, anionic surface active agents and nonionic surface active agents.

5. A charging member as set forth in claim 1, wherein said resistance regulation layer is formed by applying a coating solution prepared by dispersing or dissolving said low-resistance resin matrix and said ion conductive substance.

6. A charging member as set forth in claim 5, wherein said low-resistance resin matrix is a water-based resin, and said resistance regulation layer is formed by applying a water-based coating solution.

7. A charging device comprising a charging member for charging a body to be charged by making contact with said body to be charged, and voltage impressing means for impressing a DC voltage between said body to be charged and said charging member, wherein a charging member as set forth in any one of claims 1 to 6 is used as said charging member.

8. A method of manufacturing a charging roller comprising a step of dipping a roller in a coating material to form a coating film on the surface of the roller, wherein the dipping treatment is conducted while said coating material is kept at a substantially constant predetermined temperature in the range of 25 to 35° C.

9. A method of manufacturing a charging roller as set forth in claim 8, wherein said coating material is a water-based coating material.

10. A method of manufacturing a charging roller as set forth in claim 9, wherein said coating material is a water-based coating material of any of urethane coating material, acrylic coating material and emulsion coating material.

11. A method of manufacturing a charging roller as set forth in claim 8, wherein the temperature of said coating material is controlled to be within ±1° C. of a predetermined temperature in the range of 25 to 35° C.

12. A method of manufacturing a charging roller as set forth in claim 8, wherein said roller subjected to said dipping treatment is a roller provided with an elastic layer composed of a solid rubber or a solid or foamed urethane rubber.

13. A method of manufacturing a charging roller as set forth in claim 8, wherein in the case of successively repeating said dipping treatment of dipping one or a plurality of rollers in said coating material under predetermined raising and lowering process conditions so as thereby to successively subject a multiplicity of said rollers to said dipping treatment, the temperature of said coating material is always kept to be substantially constant during when said dipping treatment is repeated.

14. A method of manufacturing a charging roller comprising a step of simultaneously dipping a plurality of rollers in a coating material to thereby form a coating on the surface of each roller, wherein the temperatures of said plurality of rollers immediately before dipping are kept to be substantially uniform over all said rollers.

15. A method of manufacturing a charging roller as set forth in claim 14, wherein the distribution of temperature in the circumferential direction of each roller is substantially uniform.

16. A method of manufacturing a charging roller as set forth in claim 14, wherein in the case of a treatment of dipping a plurality of rollers hung in vertical direction in a coating material, the distribution of temperature at the same height of all of said hung rollers is controlled to be substantially constant.

17. A method of manufacturing a charging roller as set forth in any of claims 14 to 16, wherein the dispersion of temperature of said rollers is controlled to be within ±1° C. of the average value.

18. A method of manufacturing a charging roller as set forth in claim 14, wherein said coating material is a water-based coating material.

19. A method of manufacturing a charging roller as set forth in claim 14, wherein said coating material is a water-based coating material of any of urethane coating material, acrylic coating material and emulsion coating material.

20. A method of manufacturing a charging roller as set forth in claim 14, wherein said rollers subjected to said dipping treatment each comprise an elastic layer composed of a solid or foamed rubber or urethane.

21. A method of manufacturing a charging roller as set forth in claim 14, wherein said rollers subjected to said dipping treatment are uniformly preheated at a predetermined temperature of not lower than 30° C.

22. A method of manufacturing a charging roller comprising a step of dipping rollers in a coating material to form a coating film on the surface of each roller, wherein said plurality of rollers provided on their surfaces with said coating films by the dipping operation are hung in substantially vertical direction, and air is blown from the lower side to the upper side of said rollers to thereby dry said coating films.

23. A method of manufacturing a charging roller as set forth in claim 22, wherein air is so blown that the air velocity of the wind colliding on each roller is substantially uniform.

24. A method of manufacturing a charging roller as set forth in claim 22, wherein air is so blown that the air velocity of wind flowing along the outer peripheral surfaces of said rollers at an arbitrary position in the axial direction of said individual rollers is substantially uniform at any position on the circumferences of said rollers.

25. A method of manufacturing a charging roller as set forth in claim 23 or 24, wherein the variation of the air velocity is within ±0.1 m/s.

26. A method of manufacturing a charging roller as set forth in claim 22, wherein the air velocity is substantially constant at a predetermined velocity of not greater than 1.5 m/s.
